(19) United States
(12) Patent Application Publication
(10) Pub. No.: US 2025/0179253 A1
(43) Pub. Date: Jun. 5, 2025

(54) METHOD FOR PREPARING A THERMOPLASTIC COMPOSITION

(71) Applicant: UPM-Kymmene Corporation, Helsinki (FI)

(72) Inventors: Janak SAPKOTA, Helsinki (FI); Teemu POHJALAINEN, Helsinki (FI); Matti RISTOLAINEN, Helsinki (FI); Pasi VIRTANEN, Helsinki (FI); Harri KOSONEN, Helsinki (FI); Sakari MODIG, Helsinki (FI)

(21) Appl. No.: 18/841,702

(22) PCT Filed: Feb. 27, 2023
(86) PCT No.: PCT/FI2023/050110

§ 371 Date: Aug. 27, 2024

(30) Foreign Application Priority Data
Mar. 1, 2022 (FI) 20225185

(51) Int. Cl. C08G 81/02

(52) U.S. Cl. CPC C08G 81/027; C08G 2230/00

(57) ABSTRACT

A method for preparing a thermoplastic composition comprising grafted cellulose and/or hemicelluloses is disclosed. The method may comprise reacting a cyclic ester monomer with cellulose and/or hemicelluloses, thereby grafting the cellulose and/or hemicelluloses with the cyclic ester monomer at least partially, and thereby forming the thermoplastic composition.

### TECHNICAL FIELD

The present disclosure relates to a method for preparing a thermoplastic composition, the thermoplastic composition, and to products obtainable therefrom.

### BACKGROUND

Cellulose and hemicellulose are renewable raw materials well suited for producing thermoplastic materials.

Thermoplastic cellulose derivatives, which may be processed using conventionally used thermoplastic processing devices, such as extrusion and moulding, are of high interest as an alternative to fossil-based thermoplastic materials. In addition, based on the general considerations on the correlation between molecular structure, degree of substitution and biodegradability, cellulose derivatives may allow both thermoplastic processing and post-consumer waste management via biological decomposition.

However, balancing biodegradability, thermoplasticity and material properties may be challenging.

### SUMMARY

A method for preparing a thermoplastic composition comprising grafted cellulose and/or hemicelluloses is disclosed. The method may comprise reacting a cyclic ester monomer with cellulose and/or hemicelluloses, thereby grafting the cellulose and/or hemicelluloses with the cyclic ester monomer at least partially, and thereby forming the thermoplastic composition.

### BRIEF DESCRIPTION OF THE DRAWINGS

The accompanying drawings, which are included to provide a further understanding of the embodiments and constitute a part of this specification, illustrate various embodiments. In the drawings:

FIG. 1 illustrates an embodiment of the method for preparing a thermoplastic composition comprising grafted cellulose and/or hemicelluloses.

FIG. 2 shows the Fourier transform infrared spectroscopy (FTIR) spectra of cellulose starting material and the produced caprolactone grafted cellulose.

FIG. 3 shows the biodegradability of lactone grafted cellulose samples with different degrees of substitution. Ref.=reference; MCC=microcrystalline cellulose; 20-02831-007=grafted cellulose with a degree of substitution of 1.72 (Example 2); and 20-02831-012=grafted cellulose with a degree of substitution of 0.61 (Example 1).

### DETAILED DESCRIPTION

A method for preparing a thermoplastic composition comprising grafted cellulose and/or hemicelluloses is disclosed. The method may comprise reacting a cyclic ester monomer with cellulose and/or hemicelluloses, thereby grafting the cellulose and/or hemicelluloses with the cyclic ester monomer at least partially, and thereby forming the thermoplastic composition.

Reacting the cyclic ester monomer with the cellulose and/or hemicelluloses produces fibres containing the cellulose and/or hemicelluloses to which monomers, oligomers and/or polymers of the cyclic ester (such as a polylactone) are grafted. The cyclic ester bonds to OH groups of the cellulose and/or hemicelluloses by an ester bond. Thus the cyclic ester esterifies the cellulose and/or hemicelluloses. The reaction may be considered to be a ring-opening polymerization reaction of the cyclic ester monomer.

The grafted cellulose and/or the grafted hemicelluloses is/are thus polymerisation products of the cellulose and/or hemicelluloses and of the cyclic ester monomer.

However, the cellulose and/or hemicelluloses may be grafted with the cyclic ester monomer at least partially in the sense that at least a portion of the cellulose and/or hemicellulose molecules, fibres and/or fibre bundles, and/or at least a portion of the OH groups of the cellulose and/or hemicellulose molecules, may be grafted. The resulting thermoplastic composition may be a composite type product, i.e. a composite.

A polyester (such as a polylactone), i.e. a polyester that is not grafted to cellulose or hemicellulose, may be obtained as a side product. The polyester may be removed at least partially, if desired, for example if a certain purity level of the thermoplastic composition is desired. The free acidity content of the thermoplastic composition may be e.g. less than 2% (w/w) as determined by the standard ASTM D871-96. The polyester, such as polylactone, may be removed at least partially by extraction, for example with acetic acid, after the reaction. However, an amount of the polyester may remain in the thermoplastic composition, at least in some embodiments. It may also have a role in the material properties, such as the melting temperature of the thermoplastic composition.

An example of the grafting reaction with ε-caprolactone as the cyclic ester monomer (lactone) is depicted in Scheme 1 below.

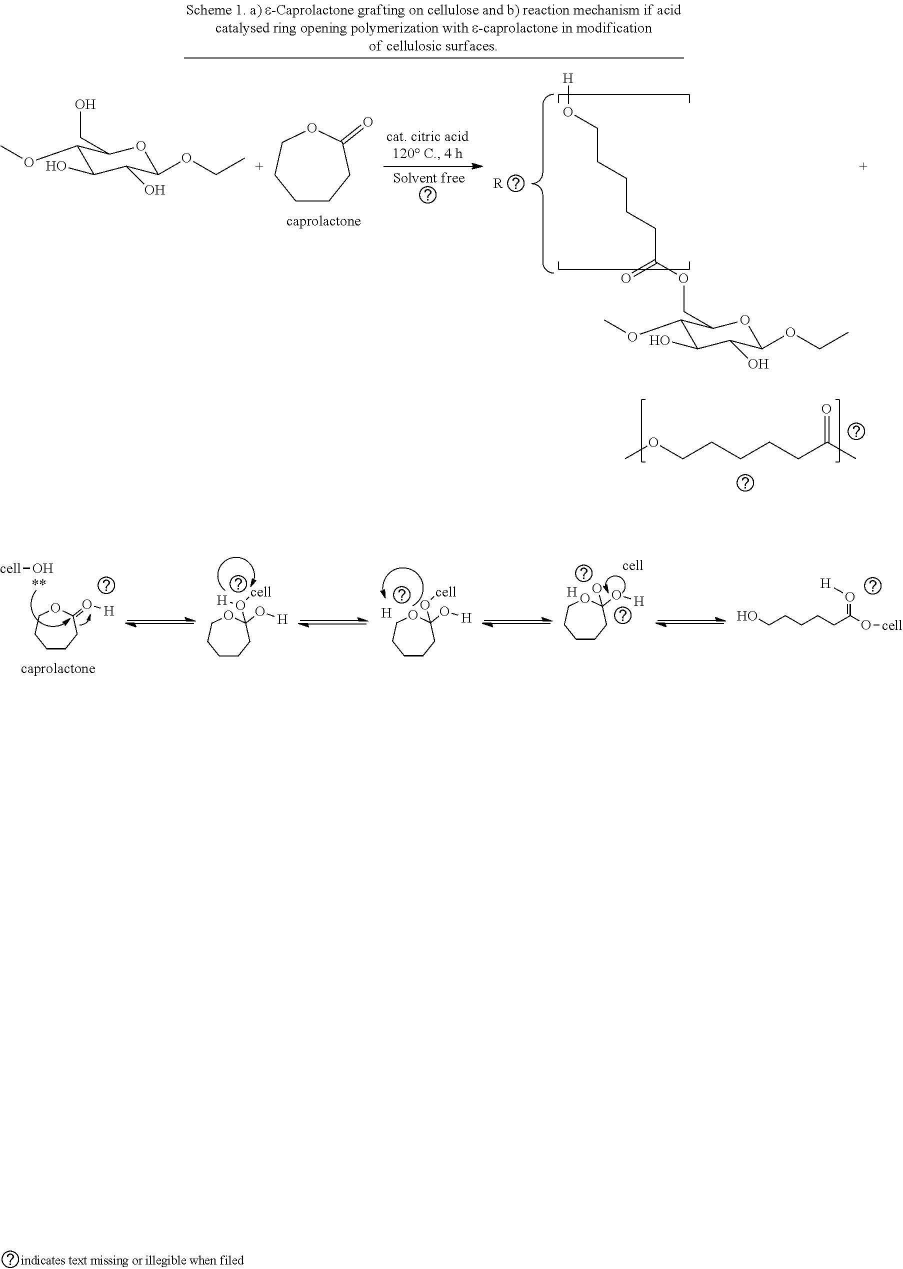

The resulting thermoplastic composition may be biodegradable.

In general, biodegradation and the biodegradability of a polymer material or composition may depend on the environmental conditions and time required for the degradation. For example, environmental conditions may be aggressive or less aggressive. The following environmental conditions may be considered to be in an order of increasing aggressiveness: marine environment, fresh water, waste water treatment plant, soil, home compost, and industrial compost. Biodegradability does not necessarily mean that the product, such as the thermoplastic composition, would be biodegradable in any one of these conditions, or in any one of these conditions in any given time. For example, in less aggressive conditions, biodegradation may require significantly longer periods of time.

The thermoplastic composition may be biodegradable as determined by the standard OECD for testing of chemicals 301 F.

The term “biodegradable” may, at least in some embodiments, refer to readily biodegradable as determined by the standard OECD for testing of chemicals 301 F (Manometric respiratory The readily test). biodegradable thermoplastic composition or thermoplastic polymer material may be a thermoplastic composition or a thermoplastic polymer material for which at least 60% biodegradability is reached within 28 days as determined by the standard OECD for testing of chemicals 301 F.

It may be possible to adjust and/or control to which extent the cellulose and/or hemicelluloses is/are grafted. For example, if mainly or only the surface of the cellulose and/or hemicelluloses is grafted (for example, if mainly or only the surface of fibre bundles containing the cellulose and/or hemicelluloses is grafted), the resulting thermoplastic composition may be more economic to produce and/or more easily recyclable. If the cellulose and/or hemicelluloses is/are grafted essentially throughout, then it may be more challenging to recycle.

The extent to which the cellulose and/or hemicelluloses is/are grafted may also affect its barrier properties. If the cellulose and/or hemicelluloses is/are grafted essentially throughout, then it may have better barrier properties than e.g. thermoplastic cellulose and/or hemicelluloses in which mainly or only the surface of the cellulose and/or hemicelluloses is grafted.

Thus the extent and/or type of grafting may be adjusted and/or controlled depending on the intended purpose, environmental impact, material energy efficiency, and/or other factors. For example, the use of toxic solvents may be minimized; the number of process steps may be minimized; atom economy may be maximized; and/or waste may be minimized.

In the context of this specification, the term “a cyclic ester monomer” or “the cyclic ester monomer” may be understood as referring to one or more cyclic ester monomers, and/or a mixture or combination thereof.

The cyclic ester monomer may be a lactone or a mixture of one or more lactones.

The lactone may be selected from lactones represented by formula (I) and/or (II)

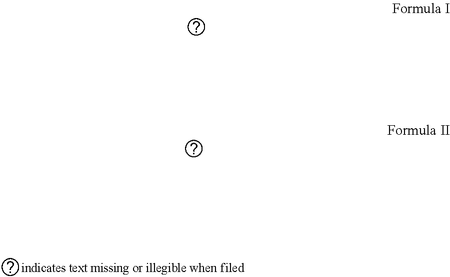

wherein R¹ and R² are each independently selected from the group consisting of H, methyl, ethyl, and propyl;
R³ and R⁴ are each independently selected from the group consisting of H, methyl, ethyl, and propyl;
A is selected from O and N;
R⁵ is selected from the group consisting of H, methyl, ethyl, and propyl when A is N, and R⁵ is absent when A is O; and
m is an integer in the range of 1 to 5.

In an embodiment, in formula I and/or II, one of R¹ and R² is H and the other one of R¹ and R² is selected from the group consisting of H, methyl, ethyl, and propyl;
one of R³ and R⁴ is H and the other one of R³ and R⁴ is selected from the group consisting of H, methyl, ethyl, propyl;
A is selected from O or N;
R⁵ is selected from the group consisting of H, methyl, ethyl, and propyl when A is N and R⁵ is absent when A is O; and
m is an integer in the range of 1 to 5.

In an embodiment, in formula I and/or II, one of R¹ and R² is H and the other one of R¹ and R² is selected from the group consisting of H, methyl, ethyl, and propyl;
one of R³ and R⁴ is H and the other one of R³ and R⁴ is selected from the group consisting of H, methyl, ethyl, propyl;
A is selected from O or N;
R⁵ is H when A is N and R⁵ is absent when A is O; and
m is an integer in the range of 1 to 5.
m may be 1, 2, 3, 4, or 5.

The cyclic ester monomer may be ε-caprolactone, γ-valerolactone, δ-valerolactone, or any mixture or combination thereof.

In the context of this specification, the term “cellulose and/or hemicelluloses” may be understood as referring to cellulose; to hemicelluloses; or to cellulose and hemicelluloses.

The cyclic ester monomer may be reacted with a mixture comprising the cellulose and the hemicelluloses. In other words, the cellulose and/or hemicelluloses may be provided as a mixture comprising cellulose and hemicelluloses. Any references to cellulose and/or hemicelluloses in this specification may thus also be understood as referring to the mixture comprising cellulose and hemicelluloses. Such a mixture may comprise or be e.g. pulp. The pulp may comprise or be e.g. wood pulp (such as hardwood and/or softwood pulp), non-wood pulp, and/or agropulp. The pulp may be chemical pulp, such as kraft pulp. The pulp may be never dried pulp, such as never dried kraft pulp.

Many sources of cellulose may additionally contain an amount of hemicelluloses. For example, pulp may comprise a mixture of cellulose and hemicelluloses. The mixture may comprise e.g. at least 3 wt-%, or at least 5 wt-%, or at least 10 wt-% of hemicelluloses on the basis of the total dry weight of the cellulose and hemicelluloses.

Cellulose is a polysaccharide containing a linear chain of a couple of thousands to ten thousand linked D-glucose units.

Hemicellulose is a heteropolymer, i.e. the term “hemicelluloses” may be understood as referring to a number of heteropolymers (matrix polysaccharides), such as arabinoxylans. Hemicelluloses are present along with cellulose in almost all terrestrial plant cell walls. While cellulose is crystalline, strong, and resistant to hydrolysis, hemicelluloses have a random, amorphous structure with little strength. In other words, the term “hemicelluloses” may be understood as referring to one or more hemicellulose molecules and their mixtures. Hemicelluloses are composed of diverse sugars, and may include xylose, arabinose, glucose, mannose, galactose, and/or rhamnose. Hemicelluloses may contain mainly D-pentose sugars, and optionally small amounts of L-sugars. Xylose is in most cases the sugar monomer present in the largest amount, although in softwoods mannose may be the most abundant sugar. Not only regular sugars can be found in hemicellulose, but also their acidified forms, for instance glucuronic acid and galacturonic acid.

The cellulose may be present as cellulose fibres, macrofibrils and/or microfibrils.

The cellulose and/or hemicelluloses or the mixture may be pretreated by thermal, mechanical, physical and/or chemical means, e.g. by drying, refining, milling, fluffing and/or mercerizing.

Such pretreatments may e.g. open the fibre structure of the cellulose and/or hemicelluloses and may thus increase the surface area of the cellulose and/or hemicelluloses, thereby exposing them to the grafting. Thus the pretreatment(s) may improve the accessibility of OH groups to chemical reactions but may also loosen the fiber structure that the cyclic ester monomer may have a better access inside the fiber structures. However, in an embodiment, the pretreatment is such that it does not fully separate cellulose chains from each other. The fibre structure of the cellulose present in the cellulose and/or hemicelluloses may be at least partially preserved after the pretreatment.

The cellulose and/or hemicelluloses or the mixture may be e.g. in the form of a slurry.

The cellulose and/or hemicelluloses or the mixture may be mercerized prior to reacting it/them with the cyclic ester monomer.

The cellulose and/or hemicelluloses or the mixture may be mercerized, dried and powdered prior to reacting it/them with the cyclic ester monomer.

The mercerizing may affect the crystal structure of cellulose. For example, amorphous cellulose chains may be arranged to cellulose chains with alternating directions. The mercerizing may be done by treating the cellulose and/or hemicelluloses with a strong base, such as a NaOH solution or other alkaline solution, for example a solution comprising 5-50 wt-%, or 7-45 wt-%, or 10-30 wt-%, or about 20 wt-% NaOH. After the mercerizing, the NaOH or other alkaline solution may be at least partially removed and/or the consistency of the pretreated cellulose and/or hemicelluloses may be increased.

The cellulose and/or hemicelluloses or the mixture may be dry and powdered cellulose and/or hemicelluloses, such as dry and powdered chemical pulp, when reacted with the cyclic ester monomer. Such dry and powdered cellulose and/or hemicelluloses or mixture may have increased reactivity towards the cyclic ester monomer.

The cyclic ester monomer may be reacted with the cellulose and/or hemicelluloses or the mixture in the presence of an acidic or basic catalyst.

The cyclic ester monomer may be reacted with the cellulose and/or hemicelluloses or the mixture in the presence of a basic catalyst. Such a basic catalyst may be or comprise, for example, a strong base, such as LiOH, NaOH, KOH, Ca(OH)₂, RbOH, Sr(OH)₂, CsOH, Ba(OH)₂, or any mixture or combination thereof; a superbase catalyst, such as ethoxide ion (C₂H₅ONa), sodium amide (NaNH₂), sodium hydride (NaH), CH₅N₃ (Guanidine), or any mixture of combination thereof; or any mixture or combination thereof.

In embodiments in which the cellulose and/or hemicelluloses or the mixture is/are mercerized prior to reacting it/them with the cyclic ester monomer, the mercerizing solution, such as a NaOH solution, may function as a basic catalyst. A part of the mercerizing solution may be removed prior to reacting with the cyclic ester monomer.

The acidic catalyst may comprise or be an organic acid, such as citric acid, tartaric acid, acetic acid, and/or any mixture or combination thereof. The acidic catalyst may comprise or be citric acid.

The cyclic ester monomer may be reacted with the cellulose and/or hemicelluloses or the mixture at a temperature in the range of about 50-210° C., or in the range of about 100-160° C., or in the range of about 110-140° C.

The cyclic ester monomer may be reacted with the cellulose and/or hemicelluloses or the mixture for at least 5 minutes, at least 1 h, or for at least 5 h, or for about 1-5 h.

In an embodiment, no additional solvents are included or added to the cyclic ester monomer and the cellulose and/or hemicelluloses or the mixture when they are reacted.

The thermoplastic composition may be processed further. The method may further comprise e.g. washing the thermoplastic composition. The method may further comprise e.g. removing unreacted cyclic ester monomer.

The method may further comprise pelletizing (i.e. forming pellets) of the thermoplastic composition or forming a powder, a film, a filament, a melt, and/or a 3D shape of the thermoplastic composition. Such products may be formed e.g. by extrusion, extrusion molding, and/or injection molding. In principle, the thermoplastic composition and the thermoplastic polymer material may be processed further as other thermoplastic materials.

A thermoplastic composition comprising grafted cellulose and/or hemicelluloses is also disclosed. The cellulose and/or hemicelluloses may be cellulose and/or hemicelluloses grafted with a polyester. The grafted polyester chains may be formed of e.g. at least 10 cyclic ester monomers. In other words, the grafted polyester chains may comprise e.g. at least 10 ester groups each. In embodiments in which the cellulose and/or hemicelluloses are grafted with a polylactone, the grafted polylactone chains may be formed of e.g. at least 10 lactone monomers.

The thermoplastic composition may be obtainable by the method according to one or more embodiments described in this specification.

Any embodiments and features described above or below may also be understood as relating to the method, to the thermoplastic composition, the thermoplastic polymer material, and/or the article according to one or more embodiments described in this specification.

The thermoplastic composition may be biodegradable.

The degree of substitution of the thermoplastic composition and/or of the grafted cellulose and/or hemicelluloses may be in the range of 0.05-2.5. Additionally or alternatively, it may be in the range of 0.1-2, or of 0.5-1.5.

The melting temperature (Tₘ) of the thermoplastic composition may be in the range of 40-230° C.

The lactone content of the thermoplastic composition may be in the range of 0.1-1000, or 0.1-200, or 0.5-200 (% of pulp weight). In this context, the term “lactone content” may be understood as referring to the (relative) amount of units derived from the lactone in the thermoplastic composition.

The lactone content of the thermoplastic composition may be measured as the total lactone content of the thermoplastic composition. The lactone content may include the lactone(s) (polylactone(s)) grafted into the cellulose and optionally the hemicelluloses (polylactone(s)) only. It may, in some embodiments, include the polymerization products of the lactone(s) alone (polylactones) that are not grafted into the cellulose and optionally the hemicelluloses. Ungrafted polylactone may be at least partially removed from the thermoplastic composition prior to measuring its lactone content.

The brightness of the thermoplastic composition may be very good. The brightness of the thermoplastic composition may be similar to pulp brightness. The thermoplastic composition, the thermoplastic polymer material, and/or the article may be recyclable. For example, they may be recyclable in a paper and cardboard recycling system, and/or in another recycling system.

A thermoplastic polymer material comprising or formed of the thermoplastic composition according to one or more embodiments described in this specification is also disclosed. The thermoplastic polymer material may optionally further comprise a biocomposite, a second thermoplastic material, a plastic and/or an additive.

An article obtainable from or formed of the thermoplastic composition according to one or more embodiments described in this specification and/or the thermoplastic polymer material according to one or more embodiments described in this specification is disclosed.

The article may be e.g. a pellet, a powder, a film, a filament, a melt, a 3D shape, a coating, a hotmelt adhesive, a container, a casing, a packaging article, a filmic label, a paper, a medical device, a plastic or composite profile, and/or a 3D printing filament.

The thermoplastic polymer material and/or the article may be biodegradable.

### EXAMPLES

Reference will now be made in detail to various embodiments, an example of which is illustrated in the accompanying drawings.

The description discloses some below embodiments in such a detail that a person skilled in the art is able to utilize the embodiments based on the disclosure. Not all steps or features of the embodiments are discussed in detail, as many of the steps or features will be obvious for the person skilled in the art based on this specification.

For reasons of simplicity, item numbers will be maintained in the following exemplary embodiments in the case of repeating components.

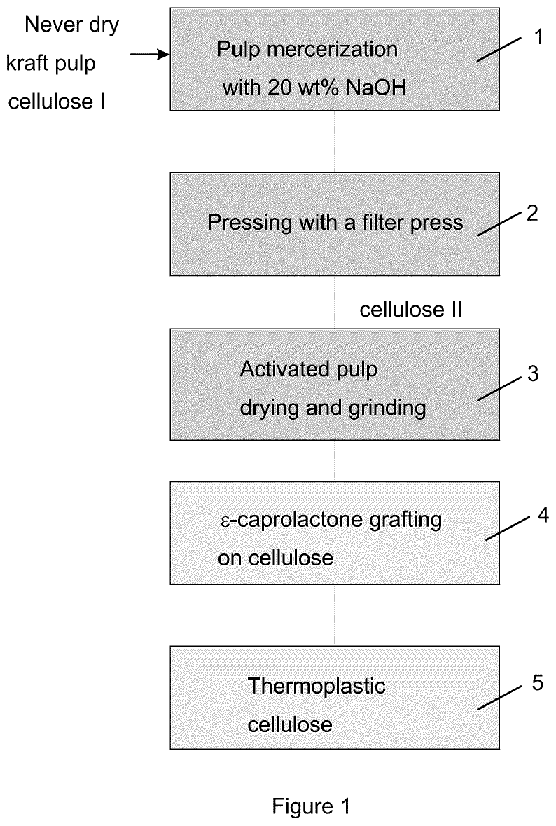

FIG. 1 illustrates an exemplary embodiment of the method. A composition comprising cellulose and hemicelluloses, in this case never dry kraft pulp (cellulose I), is mercerized with a 20 wt-% NaOH solution at 1. A skilled person will understand that various other compositions could be used instead, for example various other types of pulps, or other compositions comprising cellulose and/or hemicelluloses. At 2, the mercerized pulp is pressed with a filter press, for example Larox filter press to remove the NaOH solution at least partially as a filtrate and to increase pulp consistency. It may be beneficial to reduce the amount of NaOH in the pulp; for example, if the NaOH concentration in the pulp is too high, during heating in subsequent steps the pulp may be degraded. The cellulose in the mercerized pulp is then mainly in the form of cellulose II, while prior to the mercerization, the cellulose in the pulp is in the form of cellulose I. Although in this embodiment the pulp is pretreated, i.e. activated, by mercerizing, any other pretreatment described in this specification could be additionally or alternatively applied. The filtrate obtainable from 2 may be reused in order to minimize reagent costs and to prevent waste. At 3, the activated pulp obtained from the mercerization is dried and ground. This may be done for example in a H/C (hot/cold) mixer. The H/C mixer is a device with a mixing element. The mixing element may provide a high mixing speed, which may cause friction between fibers. The friction generates heat even over the water boiling point. In this way the pulp can be dried, mixed and refined. Running parameters may be set so as to define which dryness level will be obtained and also how much fiber will be cut into smaller fiber fractions. It can also be used for mixing and separating fiber bundles within certain limits. However, other devices, such as other similar devices, could be used for drying and/or grinding the activated pulp.

Subsequently, the dried and ground pulp is grafted by reacting it with ε-caprolactone at 4 in the presence of a suitable catalyst, for example any basic or acidic catalyst described in this specification. Although the cyclic ester monomer in this example is ε-caprolactone, any other cyclic ester monomer described in this specification could of course be used. Thus the lactone reacts with the cellulose and the hemicelluloses of the pulp, thereby grafting the cellulose and the hemicelluloses, and a thermoplastic composition, i.e. thermoplastic cellulose is obtained at 5.

### Example 1

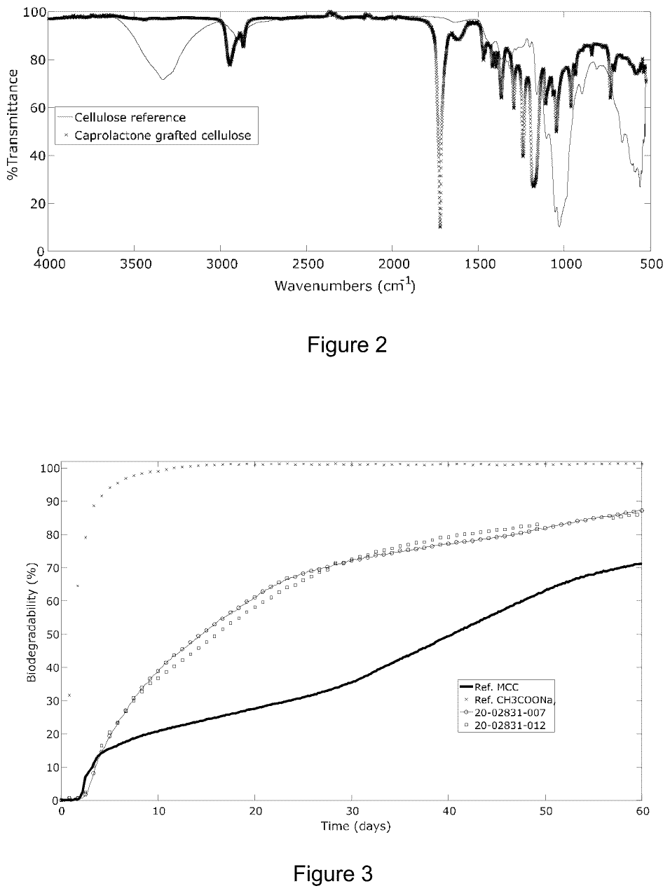

140 g ε-caprolactone and 24 g citric acid as a catalyst were added to Juccheim reactor with mixing set to about 8 Hz. The mixture was let to reflux at 120° C. for 30 minutes to dissolve the citric acid. The reactor was then cooled to 70° C. and 10 g hot cold mixer dried birch pulp was inserted to the reactor. The reaction commenced when the batch reactor temperature was raised to 120° C., and mixing set to 11 Hz. The reactor was held at this temperature for 5 h, then worked up as follows: The reactor was first cooled at 40° C., and after cooling 30 g of 20 wt-% NaOH was used to neutralize the citric acid catalyst. Then non-immobilized polycaprolactone and citric acid were extracted from the sample using 300 g acetic acid for about 60 min at 65° C. The product was then filtered from the liquids, slurried with 2 l of deionized water, the procedure being repeated until washings gave a neutral pH suspension. Water was removed as far as possible by filtration and then in an oven at 105° C. The differential scanning calorimetry (DSC) results of the product are shown in Table 1. FTIR spectrum of the product is shown in FIG. 2.

TABLE 1
The DSC results of the product.

| Parameter | Method | Product |
|---|---|---|
| Raw material | | BHKP* |
| DSC fusion heat peak [° C.] | Internal | 57 |
| DSC fusion heat onset [° C.] | Internal | 48 |
| DSC fusion heat endset [° C.] | Internal | 60 |
| Degree of substitution | ASTM | 1.7 |
| | D871-96 | |

*BHKP = bleached hardwood kraft pulp

### Example 2

500 g ε-caprolactone and 100 g catalyst citric acid are added to 3 L high consistency batch reactor with mixing set to about 40 RPM. Mixture is let to reflux at 120° C. for 30 minutes. The reactor is then cooled to 70° C. and 100 g hot cold mixer dried birch pulp is inserted to the reactor.

The reaction commences when the batch reactor temperature is raised to 120° C. The reactor is held at this temperature for 3 h then worked up as follows:

The reactor is first cooled at 60° C. and after cooling 120 g of 20 wt-% NaOH is used to neutralize citric acid catalyst. Then non-immobilized polycaprolactone and citric acid were extracted from the sample using 1.2 kg acetic acid for about 60 min at 65° C. The product is then filtered from the liquids, slurried with 2 l of deionized water, procedure being repeated until washings give neutral pH suspension. Water is removed as far as possible by filtration and then in an oven at 40° C.

### Example 3

Caprolactone grafting was performed by reacting caprolactones with birch pulp in laboratory scale using different reactors and catalysts as shown in Table 2. The resulting thermoplastic compositions were found to have varying degrees of substitution and varying melting temperatures.

The lactone grafted cellulose compositions were moldable with extrusion and injection molding and could be e.g. melt processed.

### Example 4—Biodegradability of Lactone Grafted Cellulose

Caprolactone grafted cellulose composition samples prepared as above, with different degrees of substitution (DS 1.72 Example 2 (20-02831-007) and 0.61 Example 1 (20-02831-012)) were tested for their biodegradability using the standard OECD for testing of chemicals 301 F (Manometric respiratory test). References used were microcrystalline cellulose (MCC) and CH₃COONa.

The results are shown in FIG. 3. The lactone grafted cellulose composition samples were at least 60% biodegradable within 28 days.

### Example 5—Pulp Modification with ε-caprolactone Using HC Mixer

Pulp was preactivated by mercerization using 20 wt-% sodium hydroxide, dried and powdered in a single-step drying/grinding reactor. The pulp consistency was 84% before the addition of ε-caprolactone. The NaOH solution was partially removed. The reaction was allowed to proceed in the presence of the NaOH as a basic catalyst for 1 h at a temperature of 120° C. as shown in Scheme 1 below. The resulting product was filtered, washed and dried.

TABLE 2

| | | | | Birch | | | | |
|---|---|---|---|---|---|---|---|---|
| | Reactor | | | | | | | |
| | | | | | | | 2L batch | |
| | 3L batch reactor | | | | | Imp. | reactor | H/C |
| | Reagent | | | | | | | |
| | | | ε-Cpl. | | | | | |
| | ε-Cap. | | γ-Val. | | δ-Val. | ε-Cap. | ε-Cap. | ε-Cap. |
| | Catalyst | | | | | | | |
| | A | B | A | B | A | A | A | C |
| Temperature | 120 | | | | | | | |
| Time (h) | 3 | 3 | 3 | 2 | 3 | 2 | 5 | 1 |
| DS | 0.61 | 1.1 | 0.35 | 0.08 | 1.22 | 0.07 | 1.7 | 0.2 |
| Melt temperature | 48 | 54 | 48 | 143 | 47 | 60 | 57 | 230 |
| (° C.) | | | | | | | | |

DS = Degree of substitution;
Melt temperature by DSC = Differential scanning calorimetry
Imp. = Impregnated and oven reaction
A = Citric acid;
B = Tartaric acid;
C = Base/NaOH
ε-Cpl = ε-caprolactone,
γ-Val = γ-valerolactone;
and δ-Val = δ-valerolactone

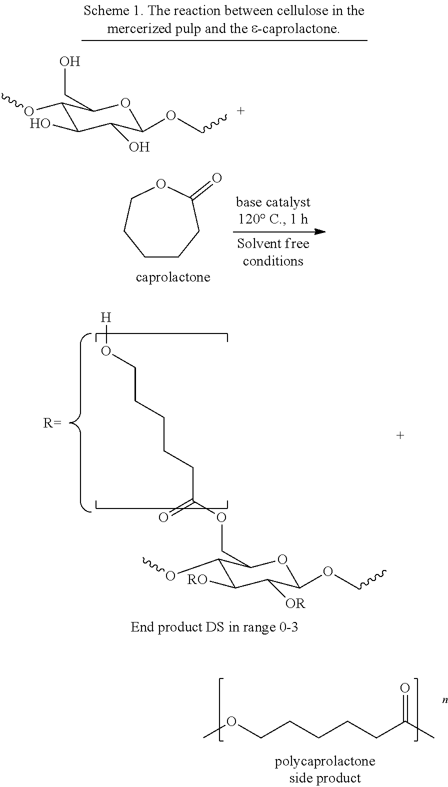

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A process, a product, or a use disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A method for preparing a thermoplastic composition comprising grafted cellulose and/or hemicelluloses, wherein the method comprises reacting a cyclic ester monomer with cellulose and/or hemicelluloses, thereby grafting the cellulose and/or hemicelluloses with the cyclic ester monomer at least partially, and thereby forming the thermoplastic composition.

2. The method according to claim 1, wherein the thermoplastic composition is biodegradable as determined by the standard OECD for testing of chemicals 301 F.

3. The method according to claim 1, wherein the cyclic ester monomer is a lactone or a mixture of two or more lactones.

4. The method according to claim 1, wherein the cyclic ester monomer is a lactone selected from lactones represented by formula (I) or (II) 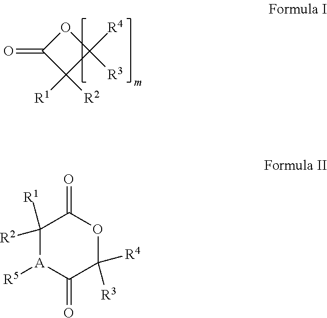
wherein R¹ and R² are each independently selected from the group consisting of H, methyl, ethyl, and propyl;
R³ and R⁴ are each independently selected from the group consisting of H, methyl, ethyl, and propyl;
A is selected from O and N;
R⁵ is selected from the group consisting of H, methyl, ethyl, and propyl when A is N, and R⁵ is absent when A is O; and
m is an integer in the range of 1 to 5.

5. The method according to claim 1, wherein the cyclic ester monomer is reacted with a mixture comprising the cellulose and the hemicelluloses.

6. The method according to claim 1, wherein the cellulose and/or hemicelluloses or the mixture is/are dry and powdered cellulose and/or hemicelluloses when reacted with the cyclic ester monomer.

7. The method according to claim 1, wherein the cellulose and/or hemicelluloses or the mixture is/are pretreated by thermal, mechanical, physical and/or chemical means prior to reacting it/them with the cyclic ester monomer.

8. The method according to claim 1, wherein the cyclic ester monomer is reacted with the cellulose and/or hemicelluloses or the mixture in the presence of an acidic or basic catalyst.

9. The method according to claim 1, wherein the cyclic ester monomer is reacted with the cellulose and/or hemicelluloses or the mixture at a temperature in the range of about 50-210° C.

10. The method according to claim 1, wherein the cyclic ester monomer is reacted with the cellulose and/or hemicelluloses or the mixture for at least 5 minutes.

11. The method according to claim 1, wherein no additional solvents are included or added to the cyclic ester monomer and the cellulose and/or hemicelluloses or the mixture when they are reacted.

12. The method according to claim 1, wherein the method further comprises pelletizing the thermoplastic composition or forming a powder, a film, a filament, a melt, and/or a 3D shape of the thermoplastic composition.

13. A thermoplastic composition comprising cellulose and/or hemicelluloses grafted with a polyester, wherein the thermoplastic composition is biodegradable.

14. The thermoplastic composition according to claim 13, wherein the thermoplastic composition is obtainable by reacting a cyclic ester monomer with cellulose and/or hemicelluloses, thereby grafting the cellulose and/or hemicelluloses with the cyclic ester monomer at least partially, and thereby forming the thermoplastic composition.

15. The method according to claim 1, wherein the degree of substitution of the composition and/or of the grafted cellulose and/or hemicelluloses is in the range of 0.05-2.5.

16. The method according to claim 1, wherein the melting temperature of the thermoplastic composition is in the range of 40-230° C.

17. The method according to claim 1, wherein the lactone content of the thermoplastic composition is in the range of 0.1-1000.

18. A thermoplastic polymer material comprising or formed of the thermoplastic composition according to claim 13, wherein the thermoplastic polymer material further comprises at least one of a biocomposite, a second thermoplastic material, a plastic, and an additive.

19. An article obtainable from or formed of the thermoplastic composition according to according to claim 13.

20. The article according to claim 19, wherein the article is a pellet, a powder, a film, a filament, a melt, a 3D shape, a coating, a hotmelt adhesive, a container, a casing, a packaging article, a filmic label, a paper, a medical device, a plastic or composite profile, and/or a 3D printing filament.
